(19) United States
(12) Patent Application Publication
(10) Pub. No.: US 2012/0262260 A1
(43) Pub. Date: Oct. 18, 2012

(54) MAGNETIC MICROPARTICLE LOCALIZATION DEVICE

(75) Inventors: James P. Light, II, Middleton, WI (US); Daniel C. Miller, Verona, WI (US)

(73) Assignee: EXACT SCIENCES CORPORATION, Madison, WI (US)

(21) Appl. No.: 13/089,116

(22) Filed: Apr. 18, 2011

(51) Int. Cl. H01F 7/00; H01F 7/06; H01F 7/02

(52) U.S. Cl. 335/306; 335/296

(57) ABSTRACT

Provided herein is technology relating to processing samples. In particular, the technology provides articles of manufacture, apparatuses, and methods related to purifying an analyte from a sample matrix using magnetic particles.

### FIELD OF INVENTION

Provided herein is technology relating to processing samples. In particular, the technology provides articles of manufacture, apparatuses, and methods related to purifying an analyte from a sample matrix using magnetic particles.

### BACKGROUND

For many applications, isolating target capture reagent microparticles from a large-volume suspension is a critical step in preparing DNA from biological samples. Biological samples have varying physical characteristics, including, but not limited to, variable viscosity, quantity and quality of suspended solids, and relative consistency. For many biological samples, microparticle capture is a time-intensive process that imposes a major bottleneck on sample processing that in turn compromises the overall efficiency and effectiveness of sample analysis and diagnostic assay.

Many conventional capture techniques employ functionalized magnetic particles (e.g., using oligonucleotides, streptavidin, antibodies, glass, etc.) to capture and isolate analytes. Such capture techniques place a magnetic device next to a sample container to localize the magnetic particles in the sample container so that the sample matrix can be removed from the captured analyte. Efficient use of magnetic capture in a quantitative diagnostic application requires capturing most of the magnetic particles in a reasonable period of time (e.g., capture of at least 95% of the magnetic particles in 10 minutes or less per sample).

A fundamental problem of conventional capture tools is that they are poorly suited for localizing microparticles from large-volume sample suspensions over a wide range of viscosities. One particular problem is that conventional large-volume capture tools are extremely slow and only weakly localize the microparticles. Thus, conventional technologies do not have the required efficiency for use in all diagnostic applications because they frequently fail to capture most of the particles from samples in a reasonable period of time or do not provide robust, strong separation. Moreover, with some samples, conventional technologies fail to capture even measurable amounts of particles within a reasonable time period.

### SUMMARY

Although there are effective systems for microparticle capture from low volume suspensions, there are few efficient tools designed for larger sample sizes and sample containers, especially for large viscous samples. Thus, provided herein is technology relating to processing samples. In particular, the technology provides articles of manufacture, apparatuses, and methods related to purifying an analyte from a sample matrix using magnetic particles. For example, embodiments of the technology are related to a device that produces a magnetic field that efficiently localizes magnetic particles from suspensions having large volumes and high viscosities (e.g., a stool sample). Related embodiments of the technologies provided herein relate to methods of isolating magnetic particles in samples having large volumes and high viscosities by placing such samples in a magnetic field that efficiently isolates magnetic particles in the sample.

Accordingly, provided herein are embodiments of an article of manufacture for localizing magnetic particles in a sample comprising a first magnetic feature and a second magnetic feature, wherein a north pole of the first magnetic feature is placed in close proximity to the sample and a south pole of the second magnetic feature is placed in close proximity to the sample. Some embodiments further comprise a non-magnetic housing, which, in some embodiments of the technology holds the sample, the first magnetic feature, and the second magnetic feature. Provided herein are embodiments of the technology wherein the housing comprises a cylindrical hole for holding the sample. While the technology is not limited in the arrangement of the magnetic features, some embodiments provide that the first magnetic feature is displaced relative to the second magnetic feature on an axis parallel to the axis of the cylindrical hole.

The magnetic features can comprise any suitable material or technology. For example, in some embodiments the first magnetic feature comprises a first plurality of magnets and the second magnetic feature comprises a second plurality of magnets. In some embodiments, the first plurality of magnets is distributed around the axis of the cylindrical hole in a first plane perpendicular to the axis of the cylindrical hole, the second plurality of magnets is distributed around the axis of the cylindrical hole in a second plane perpendicular to the axis of the cylindrical hole, the north pole of each magnet of the first plurality of magnets is nearer to the axis of the cylindrical hole than the south pole of each magnet of the first plurality of magnets, and the south pole of each magnet of the second plurality of magnets is nearer to the axis of the cylindrical hole than the north pole of each magnet of the second plurality of magnets. Embodiments further provide that the north and south poles of each magnet are on a line perpendicular to the axis of the cylindrical hole. While the technology is not limited in the number of magnets composing the magnetic features, in some embodiments the first plurality of magnets comprises six magnets and the second plurality of magnets comprises six magnets. Furthermore, while the technology is not limited in the arrangement of the magnets with respect to the cylindrical hole, in some embodiments the six magnets of the first plurality of magnets are distributed around the axis of the cylindrical hole at intervals of 60 degrees and the six magnets of the second plurality of magnets are distributed around the axis of the cylindrical hole at intervals of 60 degrees.

The article of manufacture provided herein may be made of any suitable material, for example, some embodiments provide that the technology comprises an article made of a material chosen from the group consisting of an aluminum alloy and plastic. Moreover, the magnets may be made of any suitable material, for example, in some embodiments the first magnetic feature comprises a neodymium magnet and/or the second magnetic feature comprises a neodymium magnet. In other embodiments, the first magnetic feature comprises an electromagnet and/or the second magnetic feature comprises an electromagnet.

Embodiments of the technology relate to processing large samples. For example, some embodiments of the technology provide that the sample has a volume greater than 1 milliliter and some embodiments provide that the sample has a volume greater than 10 milliliters. Samples of these sizes are often stored in 50-milliliter conical tubes. Accordingly, some embodiments of the technology provide that the cylindrical hole accommodates a 50-milliliter conical tube. In some embodiments, upon placement of a 50-milliliter conical tube into the cylindrical hole, the first plurality of magnets contacts the 50-milliliter conical tube from approximately the 4-milliliter mark to approximately the 10-milliliter mark on the tube and the second plurality of magnets contacts the 50-milliliter conical tube from approximately the 12.5-milliliter mark to approximately the 18-milliliter mark on the tube. In some embodiments, the north pole of each magnet of the first plurality of magnets touches the outside of the 50-milliliter conical tube and the south pole of each magnet of the second plurality of magnets touches the outside of the 50-milliliter conical tube. In some embodiments, the south pole of each magnet of the first plurality of magnets touches the outside of the 50-milliliter conical tube and the north pole of each magnet of the second plurality of magnets touches the outside of the 50-milliliter conical tube

An appropriate magnetic field is used to process samples of large volumes. Accordingly, in some embodiments of the technology, a first magnetic flux density produced by the first and second magnetic features is stronger than a second magnetic flux density produced by the first and second magnetic features when either a north pole of the first magnetic feature is placed in close proximity to the sample and a north pole of the second magnetic feature is placed in close proximity to the sample or a south pole of the first magnetic feature is placed in close proximity to the sample and a south pole of the second magnetic feature is placed in close proximity to the sample.

It is contemplated that the article provides technology for processing many types of samples of varying volume, viscosity, and using magnetic particles of varying sizes and quality. For example, in some embodiments, when the sample comprises a collection of paramagnetic particles of approximately 1 to 3 micrometers in diameter and the sample has a viscosity of approximately 1 centipoise, capture of approximately 98% of the paramagnetic particles occurs within approximately 5 minutes. In other embodiments, when the sample comprises a collection of paramagnetic particles of approximately 1 to 3 micrometers in diameter and the sample has a viscosity of approximately 1 centipoise, capture of approximately 90% of the paramagnetic particles occurs within approximately 2 minutes. In addition, embodiments of the device are provided, wherein, when the sample comprises a collection of paramagnetic particles of approximately 1 to 3 micrometers in diameter and the sample has a viscosity of approximately 25 centipoise, capture of approximately 98% of the paramagnetic particles occurs within approximately 60 minutes. And, some embodiments provide that, when the sample comprises a collection of paramagnetic particles of approximately 1 to 3 micrometers in diameter and the sample has a viscosity of approximately 25 centipoise, capture of approximately 90% of the paramagnetic particles occurs within approximately 30 minutes. Furthermore, in some embodiments, when the sample comprises a collection of paramagnetic particles of approximately 1 to 3 micrometers in diameter, capture of approximately 99.8% of the paramagnetic particles in a liquid having a viscosity of approximately 25 centipoise occurs within approximately 1.5 hours. In some embodiments, when the sample comprises a collection of paramagnetic particles of approximately 1 to 3 micrometers in diameter and the sample has a viscosity of approximately 25 centipoise, capture of approximately 60% of the paramagnetic particles occurs within approximately 12 minutes.

Provided herein is technology related to processing samples. In some embodiments, the technology is an article of manufacture for localizing magnetic particles in a sample comprising a housing to hold the sample and twelve magnets, wherein the magnets are arranged such that the north poles of a first set of six magnets touch the outside of a container holding the sample and the south poles of a second set of six magnets touch the outside of the container holding the sample. Some embodiments provide an apparatus for localizing magnetic particles in a sample comprising a feature to hold a sample and a feature to produce a magnetic flux in the sample, wherein the feature to produce a magnetic flux in the sample comprises a first magnet oriented with its north pole in close proximity to the sample and a second magnet oriented with its south pole in close proximity to the sample.

Also contemplated are methods for processing samples. For example, provided herein are methods for localizing magnetic particles in a sample comprising placing the sample in a magnetic field produced by a first magnet oriented with its north pole in close proximity to the sample and a second magnet oriented with its south pole in close proximity to the sample, and waiting for a time sufficient to allow the magnetic field to move the magnetic particles to the desired location. The method is used to process samples of varying volume, viscosity, using magnetic microparticles of varying sizes and qualities. For example, some embodiments provide methods wherein, when the sample comprises a collection of paramagnetic particles of approximately 1 to 3 micrometers in diameter and the sample has a viscosity of approximately 1 centipoise, capture of approximately 98% of the paramagnetic particles occurs within approximately 5 minutes. In some embodiments, when the sample comprises a collection of paramagnetic particles of approximately 1 to 3 micrometers in diameter and the sample has a viscosity of approximately 1 centipoise, capture of approximately 90% of the paramagnetic particles occurs within approximately 2 minutes. And, in some embodiments, when the sample comprises a collection of paramagnetic particles of approximately 1 to 3 micrometers in diameter and the sample has a viscosity of approximately 25 centipoise, capture of approximately 98% of the paramagnetic particles occurs within approximately 60 minutes. Additional embodiments provide methods wherein, when the sample comprises a collection of paramagnetic particles of approximately 1 to 3 micrometers in diameter and the sample has a viscosity of approximately 25 centipoise, capture of approximately 90% of the paramagnetic particles occurs within approximately 30 minutes. Further embodiments provided relate to methods wherein, when the sample comprises a collection of paramagnetic particles of approximately 1 to 3 micrometers in diameter, capture of approximately 99.8% of the paramagnetic particles in a liquid having a viscosity of approximately 25 centipoise occurs within approximately 1.5 hours.

Additional embodiments will be apparent to persons skilled in the relevant art based on the teachings contained herein.

### BRIEF DESCRIPTION OF THE DRAWINGS

These and other features, aspects, and advantages of the present technology will become better understood with regard to the following drawings:

FIG. 1 is a cross-sectional view of an embodiment of the technology.

FIG. 2 is a top view of components used to construct the embodiment shown in FIG. 1. FIG. 2A is a top view of a holder piece and FIG. 2B is a top view of a base piece.

FIG. 3 is a cross-sectional view of components used to construct an embodiment of the technology shown in FIG. 1. FIG. 3A is a cross-sectional view of a holder piece and FIG. 3B is a cross-sectional view of a base piece with a 50-milliliter conical tube shown inserted into a conical depression in the base piece.

FIG. 4 is a cross-sectional view of components used to construct an embodiment of the technology shown in FIG. 1. FIG. 4A is cross-sectional view of a holder piece with magnets inserted into magnet slots and FIG. 4B is a cross-sectional view of a variant base piece that has no magnet slots.

FIG. 5 is a photograph showing an embodiment of the technology. FIG. 5A is a partial top perspective view of the device and FIG. 5B is a top view of the device.

FIG. 6 is a drawing of a hat piece used to construct an embodiment of the device shown in FIG. 5. FIG. 6A is a top view and FIG. 6B is a side cross-sectional view.

FIG. 7 is a drawing of an upper holder piece used to construct an embodiment of the device shown in FIG. 5. FIG. 7A is a top view, FIG. 7B is a detail of a region of the top view, and FIG. 7C is a side cross-sectional view.

FIG. 8 is a drawing of a lower body piece used to construct an embodiment of the device shown in FIG. 5. FIG. 8A is a top view, FIG. 8B is a detail of a region of the top view, and FIG. 8C is a side cross-sectional view.

FIG. 9 is a drawing of a base piece used to construct an embodiment of the device shown in FIG. 5. FIG. 9A is a top view and FIG. 9B is a side cross-sectional view.

FIG. 10 is a drawing demonstrating a quality of a predicted magnetic flux produced by magnets. FIG. 10A shows magnets in a “N-N” configuration and

FIG. 10B show magnets in a “S-N” configuration.

FIG. 11 is a plot of data comparing the localization efficiency of the conventional technology to an embodiment of the technology provided herein.

FIG. 12 is a plot of data comparing the localization efficiency of an embodiment of the technology using magnets in the “N-N” configuration and an embodiment of the technology using magnets in the “S-N” configuration.

FIG. 13 is a plot of data comparing the localization efficiency of an embodiment of the technology using grade N40 neodymium magnets and an embodiment of the technology using grade N52 neodymium magnets.

FIG. 14 is a plot of data comparing the localization efficiency of the conventional technology for samples having viscosities of 1 centipoise and 25 centipoise.

FIG. 15 is a plot of data comparing the localization efficiency of an embodiment of the technology provided herein for samples having viscosities of 1 centipoise and 25 centipoise.

FIG. 16 is a plot of data comparing the localization efficiency of an embodiment of the technology provided herein for samples comprising Sera-Mag SpeedBeads and standard magnetic microparticles.

FIG. 17 is a plot of data comparing the localization efficiency of the conventional technology and an embodiment of the technology provided herein comprising grade 52 neodymium magnets in the “S-N’ configuration for a sample having a viscosity of 25 centipoise and comprising Sera-Mag SpeedBeads.

### DETAILED DESCRIPTION

Provided herein is technology relating to processing samples. In particular, the technology provides articles of manufacture, apparatuses, and methods related to purifying an analyte from a sample matrix using magnetic particles.

Samples often include or are treated to release materials capable of interfering with the detection of an analyte (e.g., a nucleic acid). To remove interfering materials, samples can be treated with a target capture reagent that includes a magnetically-responsive solid support for immobilizing the analyte.

Suitable solid supports are paramagnetic particles (e.g., Sera-Mag magnetic particles, available from Thermo Scientific) functionalized with moieties specific for the target analyte (e.g., oligonucleotides, streptavidin, antibodies, etc.). When the solid supports are brought within a magnetic field, the solid supports are drawn out of suspension and aggregate adjacent a surface of a sample holding container, thereby isolating any immobilized analyte within the container. Non-immobilized materials in the sample can then be aspirated or otherwise separated from the immobilized analyte. One or more wash steps may be performed to further purify the analyte.

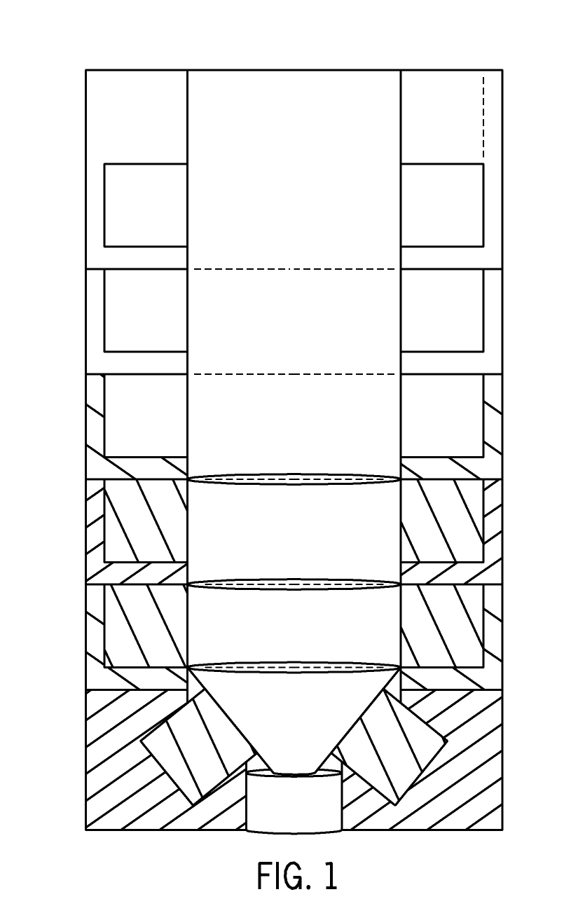

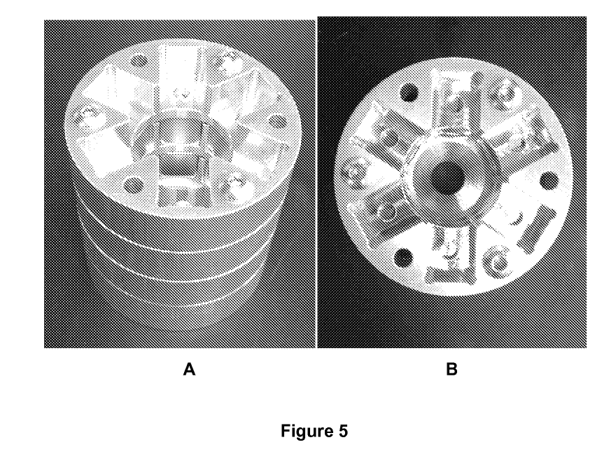

Methods, systems, and apparatuses for performing a procedure for isolating and separating an analyte of interest from other components of a sample are embodied in a magnetic microparticle localization device, embodiments of which are shown, e.g., in FIG. 1 and FIG. 5. The magnetic microparticle localization device comprises a housing having a cylindrical hole configured to receive a sample vessel that contains a sample material comprising a target capture reagent including magnetically-responsive solid supports (magnetic microparticles) adapted to bind directly or indirectly to an analyte of interest, such as a nucleic acid, that may be present in the sample.

The magnetic microparticle localization device includes magnets for attracting the magnetically-responsive solid supports to a side wall of a sample vessel. A sample vessel containing sample material and a target capture reagent that includes magnetically-responsive solid supports is placed into the magnetic microparticle localization device and left for a specified dwell time to draw magnetically-responsive solid supports to the side of the sample vessel. After the specified dwell time, the fluid contents of the sample vessel can be aspirated from the sample vessel. After removing the sample vessel from the magnetic microparticle localization device, a wash solution or other suspending fluid can be dispensed into the sample vessel to rinse the magnetically-responsive solid supports from the sample vessel wall and re-suspend the magnetically-responsive solid supports. The sample vessel can be returned to the magnetic microparticle localization device to draw the magnetically-responsive solid supports to the walls of the sample vessel and out of suspension. This process of applying a magnetic force for a specified dwell time, aspirating fluid from the sample vessel, and re-suspending the magnetically-responsive solid supports may be repeated a specified number of times.

The magnetic microparticle localization device may be part of an instrument including various modules configured to receive one or more sample vessels within which is performed one or more steps of a multi-step analytical process, such as a nucleic acid test or other chemical, biochemical, or biological process. The instrument may further include a transfer apparatus configured to transfer sample vessels between the various modules, including transporting sample vessels into and out of the magnetic microparticle localization device. The instrument and each individual component, such as the magnetic microparticle localization device, is automated and may be controlled by an instrument control module including a microprocessor executing an instrument control program stored thereon.

Further details of the magnetic microparticle localization device are described below.

### DEFINITIONS

To facilitate an understanding of the present technology, a number of terms and phrases are defined below. Additional definitions are set forth throughout the

### DETAILED DESCRIPTION

As used herein, “a” or “an” or “the” can mean one or more than one. For example, “a” cell can mean one cell or a plurality of cells. As used herein, a “magnet” is a material or object that produces a magnetic field. A magnet may be a permanent magnet or an electromagnet.

As used herein, the term “sample” is used in its broadest sense. In one sense, it is meant to include a specimen or culture obtained from any source, as well as biological and environmental samples. Biological samples may be obtained from animals (including humans) and encompass fluids, solids, tissues, and gases.

Biological samples include blood products, such as plasma, serum and the like, stool samples, urine, secretions, cells, tissues, etc. Environmental samples include environmental material such as surface matter, soil, water, a biofilm, crystals and industrial samples. Such examples are not however to be construed as limiting the sample types applicable to the described compositions and methods.

### EMBODIMENTS OF THE TECHNOLOGY

Although the disclosure herein refers to certain illustrated embodiments, it is to be understood that these embodiments are presented by way of example and not by way of limitation.

### Magnetic Microparticle Localizing Devices

FIG. 1 shows a first embodiment of the magnetic microparticle localizing device. The device 100 comprises one or more holder pieces 110 and a base piece 120. A plurality of magnet slots 111 in the holder pieces 110 and a plurality of magnet slots 121 in the base piece 120 are adapted to hold a plurality of appropriately sized magnets 130. The one or more holder pieces 110 are stacked upon a base piece 120 and secured together to form the device 100.

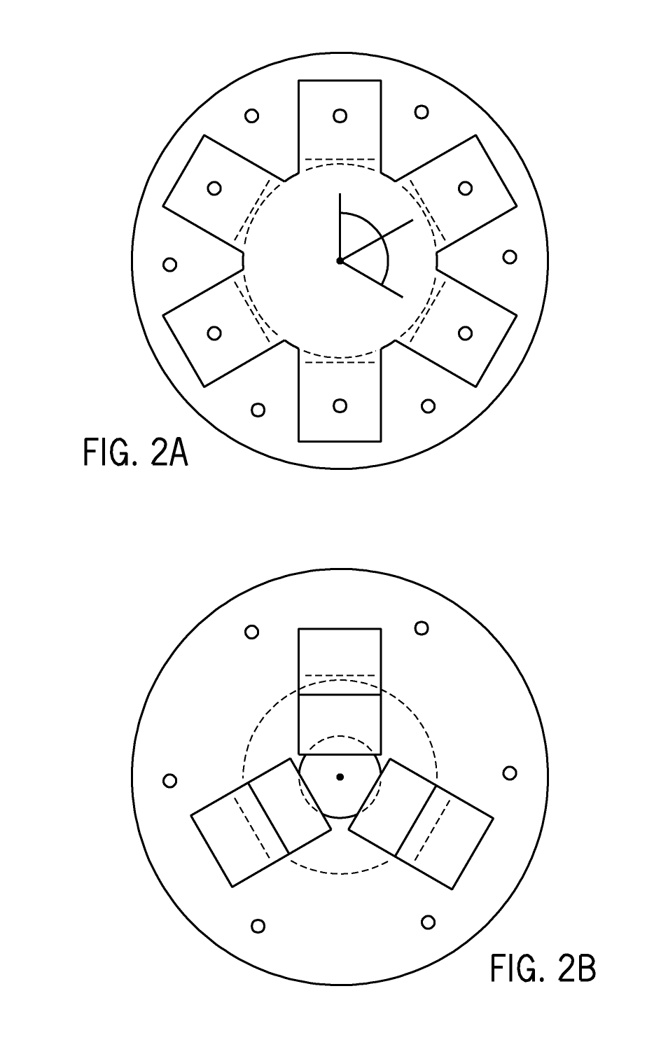

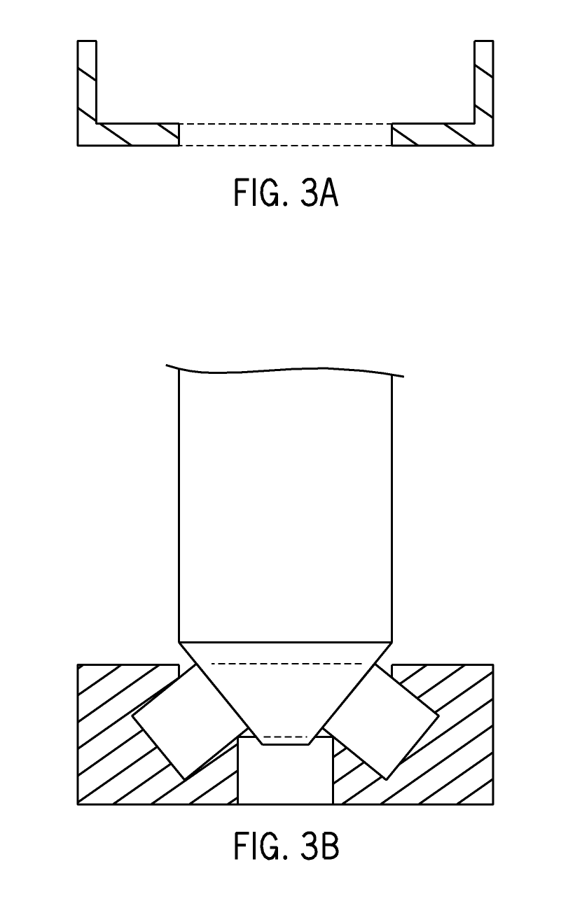

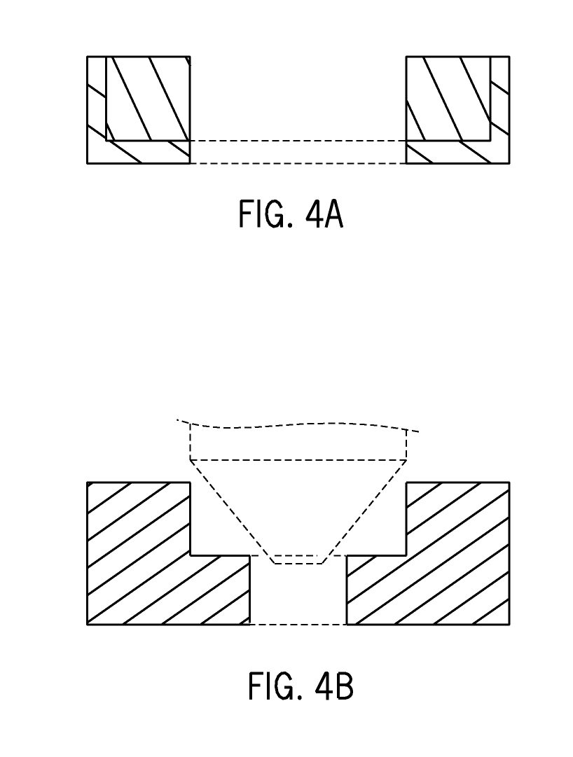

Holder and base pieces used to assemble the device 100 are shown in FIG. 2, FIG. 3, and FIG. 4. Each holder piece 110 has a hole 112 appropriate for holding a 50-milliliter conical tube 900 and the base piece 120 has a conical depression 122 for accepting the bottom of a 50-milliliter conical tube 900. In this particular embodiment of the device, each holder piece 110 has six magnet slots 111 for holding in place the magnets and the base piece 120 has three magnet slots 121 for holding in place the magnets. Magnets can be placed in as many magnet slots 111 and 121 as required for the particular sample processing to which the device is applied. Furthermore, each magnet can be placed in the orientation desired for the sample processing (e.g., north pole toward the hole 112 and/or conical depression 122 or south pole toward the hole 112 and/or conical depression 122). The holder piece 110 has a plurality of screw holes 113 and the base piece 120 has a plurality of screw holes 123 for securing the assembled device 100 with screws. FIG. 4B shows a variation of the base piece 120 that does not have magnet slots.

FIG. 5 shows a second embodiment of the magnetic microparticle localization device. The device 300 comprises a base piece 310, a lower body piece 320 stacked on the base piece 310, an upper body piece 330 stacked on the lower body piece 320, and a hat piece 340 stacked on the upper body piece 330. The assembled device has a cylindrical hole 301 appropriate to hold a 50-milliliter conical tube.

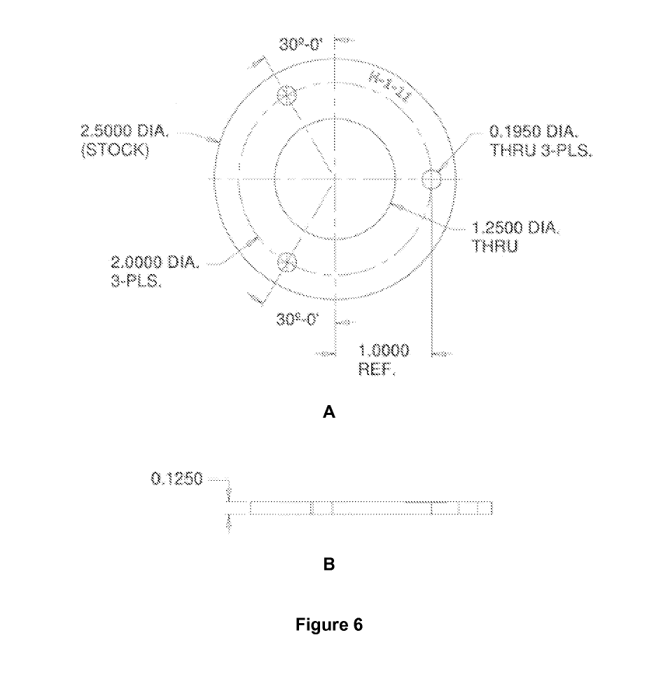

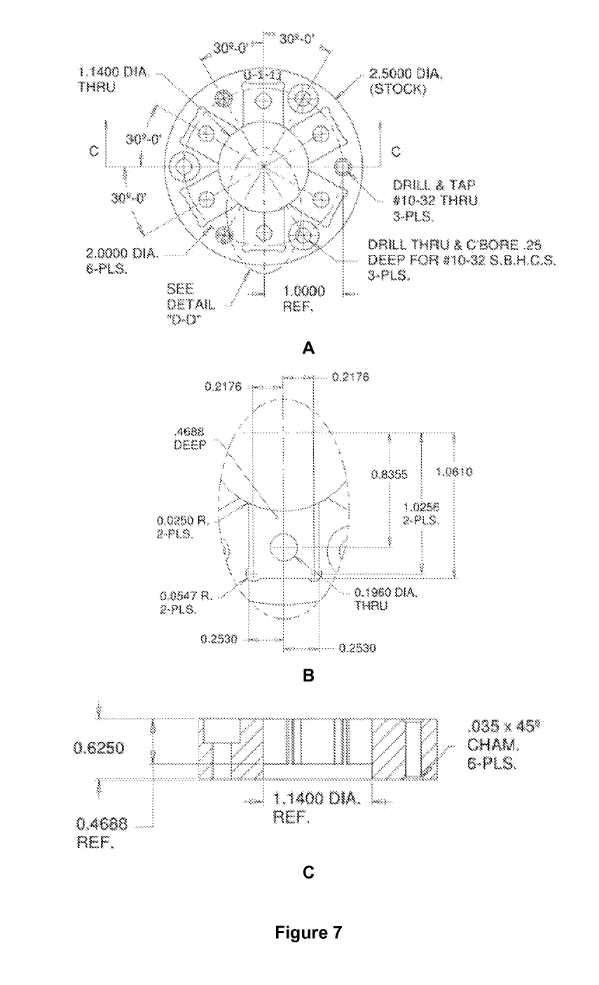

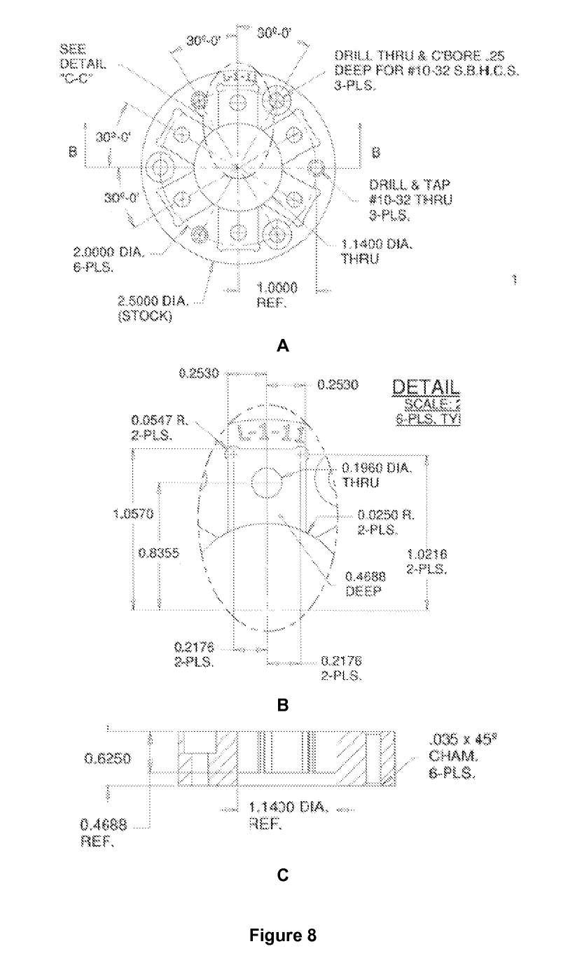

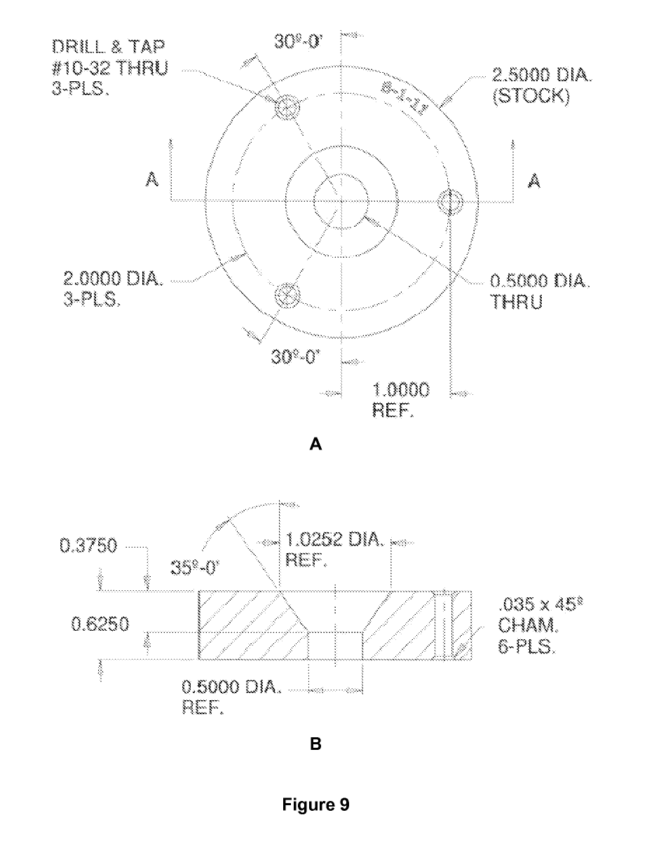

The hat piece 340 shown in FIG. 6 has a hole 341 appropriate to fit a 50-milliliter conical tube. Screw holes 343 are used to secure the assembled device 300. The upper body piece 330 is shown in FIG. 7. The upper body piece 330 has a hole 331 appropriate to fit a 50-milliliter conical tube, six magnet slots 332, and screw holes 333 used to secure the assembled device 300. The lower body piece 320 is shown in FIG. 8. The lower body piece 320 has a hole 321 appropriate to fit a 50-milliliter conical tube, six magnet slots 322, and screw holes 323 used to secure the assembled device 300. The base piece 310 is shown in FIG. 9. The base piece 310 has a conical depression 311 appropriate to accept a 50-milliliter conical tube and screw holes 313 to secure the assembled device 300.

As the pieces are stacked for assembly, appropriately sized magnets are placed in the magnet slots 332 and 322 in the desired orientation (e.g., to produce an N-N or S-N configuration as discussed below). After assembly, the entire device is secured with screws, thus securing the magnets in the magnet slots 332 and 322.

When assembled, the hole 341 of the hat piece 340, the hole 331 of the upper body piece 330, the hole 321 of the lower body piece 320, and the conical depression 311 of the base piece 310 are in register such that they form a cylindrical hole 301 in the device 300 appropriate to hold securely a 50-milliliter conical tube. Likewise, the screw holes 343 of the hat piece 340, the screw holes 333 of the upper body piece 330, the screw holes 323 of the lower body piece 320, and the screw holes 313 of the base piece 310 are in register such that screws are inserted through the registered screw holes to secure the assembled device.

When a 50-milliliter conical tube is placed into the cylindrical hole 301 of the device, the magnets placed in the magnet slots 322 of the lower body piece 320 contact the outside of the 50-milliliter conical tube from approximately the 4-milliliter mark to approximately the 10-milliliter mark on the tube and the magnets placed in the magnet slots 332 of the upper body piece 330 contact the 50-milliliter conical tube from approximately the 12.5-milliliter mark to approximately the 18-milliliter mark on the tube. Magnets can be placed in as many magnet slots 322 and 332 as required for the particular sample processing to which the device is applied. Furthermore, each magnet can be placed in the orientation desired for the particular sample processing application (e.g., north pole toward the cylindrical hole 301 or south pole toward the cylindrical hole 301 to produce an N-N or S-N configuration as discussed below). While the technology is described with reference to a 50-milliliter conical tube, it is to be understood that embodiments of the devices can have other geometries (e.g., other hole sizes) appropriate for other types, shapes, and sizes of vessels and/or tubes.

### Materials

A variety of materials find use in constructing the magnetic microparticle localizing device. In some embodiments, the device is constructed from a non-magnetic material. For example, particular embodiments of the device are machined from components made from aluminum or an aluminum alloy. In specific embodiments, particular aluminum alloys are used, for example, an aluminum alloy in the 6000 series such as 6061 aluminum alloy. Also contemplated are embodiments of the magnetic microparticle localizing device wherein the components are wholly or partially made from other materials, e.g., plastic, glass, wood, paper, rubber, and the like. One of ordinary skill in the art has the requisite knowledge to select appropriate materials for each component having the required characteristics for machining, stability, durability, magnetism or non-magnetism, cost, and ease of production.

### Magnets

The magnetic microparticle localizing device comprises magnets to localize the microparticles in samples placed in the cylindrical hole. Any magnet can be used provided it produces a magnetic field strong enough to localize magnetic microparticles in a sample in accordance with the technology provided herein. In some embodiments, the magnet is a permanent magnet. Types of permanent magnets include, but are not limited to, those made from magnetic metallic elements (e.g., iron, cobalt, and nickel) or magnetic rare earth elements (e.g., neodymium, samarium, gadolinium, and dysprosium). In addition, ceramic, ferrite, alnico, and ticonal magnets find use in some embodiments. Also contemplated are embodiments of the device wherein electromagnets (e.g., one comprising a ferromagnetic core) produce the magnetic field.

Particularly strong magnetic fields (e.g., in some instances producing magnetic flux densities greater than 1.4 tesla) are produced by rare-earth magnets, e.g., neodymium magnets and samarium-cobalt magnets. Accordingly, such magnets find use in the technology provided herein. The strong fields produced are a result of rare-earth compounds having crystalline structures with very high magnetic anisotropy and atoms that can retain high magnetic moments in the solid state as a consequence of incomplete filling of the f-shell, which can contain up to 7 unpaired electrons with aligned spins. Electrons in such orbitals are strongly localized and therefore easily retain their magnetic moments and function as paramagnetic centers.

While not limited in the types of magnets that are used, neodymium magnets are currently the strongest and most cost-effective type of rare-earth magnet available. Neodymium alloy (Nd₂Fe₁₄B) is made of neodymium, iron, and boron, and the magnetic properties of neodymium magnets depend on the alloy composition, microstructure, and manufacturing technique employed. Neodymium magnets are graded based on the strength of the magnetic field they produce, which depends in part on the material from which they are made, their shape, and quality of fabrication. Generally, neodymium magnets are given a rating designated by the letter “N” followed by a number, with higher numbers describing a stronger magnet (i.e., produces a higher magnetic flux density) than lower numbers. For example, a grade N52 magnet is stronger than a grade N40 magnet.

### Samples

While not limited to the types of samples that can be processed using embodiments of the magnetic microparticle localization device, the device is appropriate for processing many types of samples (e.g., biological samples, e.g., blood, serum, plasma, stool samples, urine, tissue suspensions, cell suspensions, saliva, and the like) using magnetic beads. In some embodiments the magnetic beads are functionalized to produce a target capture reagent appropriate for isolating the desired analyte as a step in further characterizing the analyte. Various physical variables affect the efficiency of magnetic microparticle localization, for example, the strength of the magnetic field produced by the localization device, the viscosity of the sample, the size and composition of the magnetic microparticles, etc.

The technology provided herein is particularly adapted to process samples having a high viscosity, such as stool samples. Sample viscosity can have a profound effect on localization efficiency due to the viscous drag affecting the magnetic microparticles. Stool samples have viscosities ranging from 20 centipoise to 40 centipoise, whereas, for reference, water at 20° C. has a viscosity of approximately 1 centipoise and honey at 20° C. has a viscosity of approximately 3,000 centipoise.

These and other features, aspects, and advantages of embodiments of the present technology will become better understood with regard to the following examples.

### EXAMPLES

### Methods

Each test sample contained 10 milliliters of stool homogenization buffer, 7 milliliters of guanidine thiocyanate, and 100 microliters of paramagnetic microparticles (Sera-Mag Microparticles, Thermo Scientific) to provide a solution comprising approximately 1% solids. Where indicated, solutions having a viscosity of 25 centipoise were produced by additionally dissolving 2% methyl cellulose in the test sample at 200 milligrams per 9.8 milliliters. For testing, a 17-milliliter sample in a 50-milliliter conical tube was vortexed and placed in either a conventional magnetic separation device (a Promega PolyA Tract backed with a 1-inch outer diameter×one-eighth-inch thick N52 neodymium magnet) or an embodiment of the magnetic microparticle localization device provided herein comprising either grade N40 or grade N52 one-half-inch neodymium cube magnets. Microparticles that remained in suspension after localization were aspirated using a 10-milliliter serological pipette at a flow rate of approximately 1 milliliter per second. Microparticles were quantified by spectrometry using a reference solution of 10 milliliters of stool homogenization buffer mixed with 7 milliliters of guanidine thiocyanate.

### Example 1

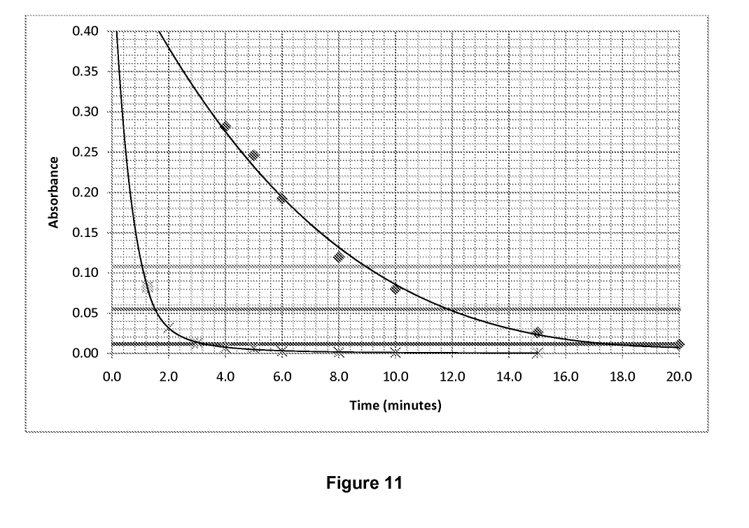

During the development of embodiments of the technology provided herein, experiments were performed to compare the localization efficiencies of the conventional technology and the technology provided herein. Test solutions were placed in either a conventional magnetic separation device or an embodiment of the magnetic microparticle localization device comprising grade 40 neodymium magnets all oriented with their north poles facing the sample. Samples were exposed to the magnetic field, the liquid was aspirated at the time intervals indicated for each sample, and the particles remaining in suspension were quantified by spectrometry. A decrease in absorbance indicates a decreased concentration or number of microparticles suspended in solution (i.e., more particles are localized and removed by aspiration from suspension by the magnetic separation). Results are provided below in Table 1 and in FIG. 11. In FIG. 11, data collected for the conventional technology are shown with diamonds (♦) and data collected for the magnetic microparticle localization device are shown with crosses (x).

TABLE 1

| | | |
|---|---|---|
| | | Particles remaining |
| Time | Average | in suspension |
| (min) | absorbance | (%) |

Conventional technology

| | | |
|---|---|---|
| 5.00 | 0.2460 | 48.33 |
| 10.00 | 0.0800 | 15.35 |
| 15.00 | 0.0260 | 4.63 |
| 20.00 | 0.0110 | 1.65 |

Magnetic microparticle localization device
(N40 magnet/N-N orientation)

| | | |
|---|---|---|
| 1.25 | 0.0525 | 9.89 |
| 3.00 | 0.0064 | 0.73 |
| 4.00 | 0.0045 | 0.36 |
| 5.00 | 0.0033 | 0.13 |

### Example 2

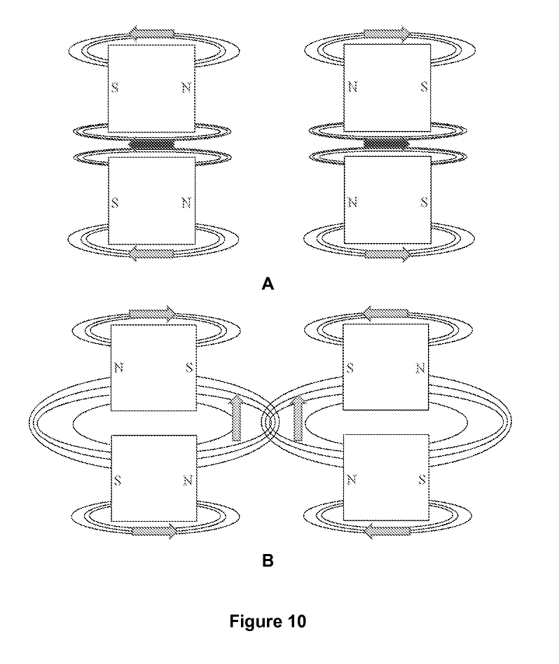

During the development of embodiments of the technology provided herein, experiments were performed to compare the localization efficiencies of the magnetic microparticle localization device using neodymium N40 magnets in the N-N and S-N configurations. In the N-N configuration, the magnets in the upper and lower body pieces 330 and 320 are all oriented with their north poles (or, equivalently, with all their south poles) toward the cylindrical hole 301. In the S-N configuration, the magnets in the upper body piece 330 are oriented with their south poles toward the cylindrical hole 301 and the magnets in the lower body piece 320 are oriented with their north poles toward the cylindrical hole 301. An equivalent configuration is one in which the magnets in the upper body piece 330 are oriented with their north poles toward the cylindrical hole 301 and the magnets in the lower body piece 320 are oriented with their south poles toward the cylindrical hole 301. It is contemplated that the N-N and S-N configurations produce magnetic fields having different characteristics (e.g., see FIG. 10), some of which are contemplated to be advantageous for localizing magnetic particles in a sample.

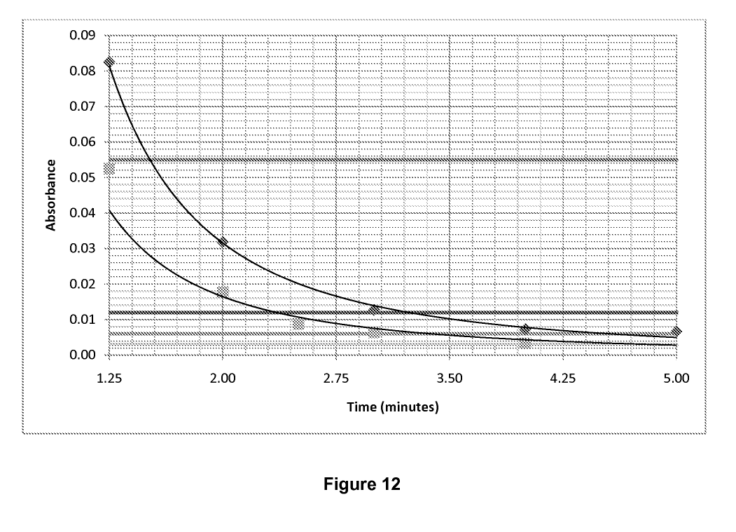

Test solutions were placed in the magnetic microparticle localization device with the appropriate magnet configuration (i.e., N-N or S-N) for testing. Samples were exposed to the magnetic field, the liquid was aspirated at the time intervals indicated for each sample, and the particles remaining in suspension were quantified by spectrometry. A decrease in absorbance indicates a decreased concentration of microparticles suspended in solution (i.e., more particles localized and removed from suspension by magnetic separation). Results are provided below in Table 2 and in FIG. 12. In FIG. 12, data collected for the N-N configuration are shown with diamonds (♦) and data collected for the S-N configuration are shown with squares (▪).

TABLE 2

| | N-N configuration | | S-N configuration | |
|---|---|---|---|---|
| | | Particles | | Particles |
| | | remaining in | | remaining in |
| Time | Average | suspension | Average | suspension |
| (min) | absorbance | (%) | absorbance | (%) |
| 1.25 | 0.0825 | 15.85 | 0.0525 | 9.89 |
| 3.00 | 0.0128 | 2.00 | 0.0064 | 0.73 |
| 4.00 | 0.0073 | 0.90 | 0.0045 | 0.36 |
| 5.00 | 0.0067 | 0.79 | 0.0033 | 0.13 |

### Example 3

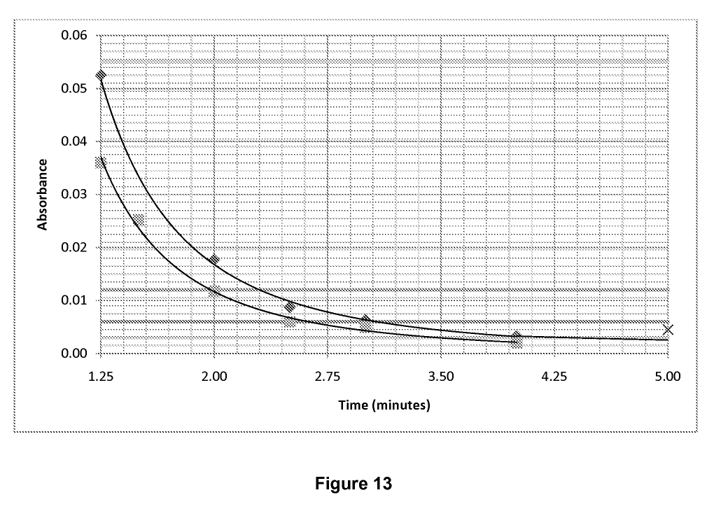

During the development of embodiments of the technology provided herein, experiments were performed to compare the localization efficiencies of the magnetic microparticle localization device using grade N40 and grade N52 neodymium magnets. Test solutions were placed in the magnetic microparticle localization device comprising either N40 or N52 magnets in the S-N configuration for testing. Samples were exposed to the magnetic field, the liquid was aspirated at the time intervals indicated for each sample, and the particles remaining in suspension were quantified by spectrometry. A decrease in absorbance indicates a decreased concentration of microparticles suspended in solution (i.e., more particles localized and removed from suspension by magnetic separation). Results are provided below in Table 3 and in FIG. 13. In FIG. 13, data collected for the grade N40 magnets are shown with diamonds (♦) and data collected for the grade N52 magnets are shown with squares (▪).

TABLE 3

| | Grade N40 magnets (S-N) | | Grade N52 magnets (S-N) | |
|---|---|---|---|---|
| | | Particles | | Particles |
| | | remaining in | | remaining in |
| Time | Average | suspension | Average | suspension |
| (min) | absorbance | (%) | absorbance | (%) |
| 1.25 | 0.0525 | 9.89 | 0.0360 | 6.61 |
| 3.00 | 0.0064 | 0.73 | 0.0118 | 1.80 |
| 4.00 | 0.0045 | 0.36 | 0.0050 | 0.46 |
| 5.00 | 0.0033 | 0.13 | 0.0020 | 0.01 |

### Example 4

During the development of embodiments of the technology provided herein, experiments were performed to compare the localization efficiencies of the conventional technology (e.g., a Promega PolyA Tract backed with a 1-inch outer diameter×one-eighth-inch thick N52 neodymium magnet) and the magnetic microparticle localizing device (using grade N52 neodymium magnets in the S-N configuration) for samples of low (i.e., 1 centipoise) and high (i.e., 25 centipoise) viscosities.

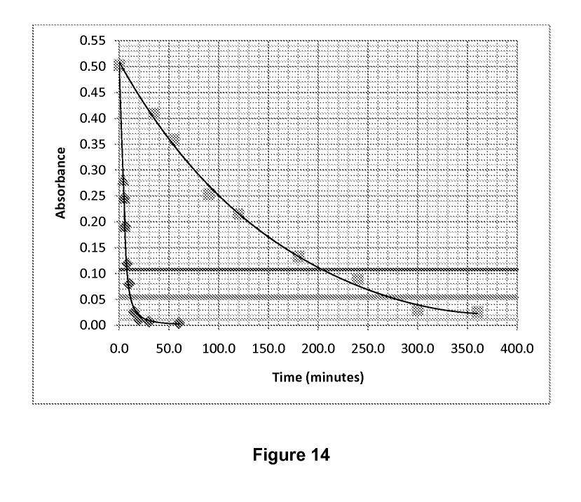

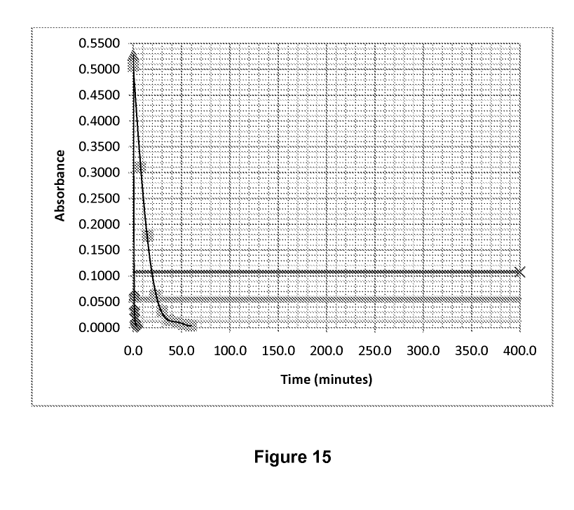

Test solutions of the appropriate viscosity (e.g., 1 or 25 centipoise) were placed in a conventional device or an embodiment of the technology provided herein for testing. Samples were exposed to the magnetic field, the liquid was aspirated at the time intervals indicated for each sample, and the particles remaining in suspension were quantified by spectrometry. A decrease in absorbance indicates a decreased concentration of microparticles suspended in solution (i.e., more particles localized and removed from suspension by magnetic separation). Results for the conventional technology are provided below in Table 4 and in FIG. 14. Results for the magnetic microparticle localization device are provided below in Table 4 and in FIG. 15. In FIGS. 14 and 15, data collected for the 25 centipoise solution are shown with squares (▪) and data collected for the 1 centipoise solution are shown with diamonds (♦).

TABLE 4

| | | |
|---|---|---|
| | | Particles remaining |
| Time | Average | in suspension |
| (min) | absorbance | (%) |

Conventional technology (25 centipoise)

| | | |
|---|---|---|
| 10.00 | 0.4750 | 93.81 |
| 30.00 | 0.4090 | 80.70 |
| 120.00 | 0.2150 | 42.17 |
| 360.00 | 0.0260 | 4.63 |

Magnetic microparticle localization device (25 centipoise)

| | | |
|---|---|---|
| 10.00 | 0.2600 | 51.10 |
| 20.00 | 0.0980 | 18.93 |
| 30.00 | 0.0280 | 5.03 |
| 40.00 | 0.0123 | 1.91 |

### Example 5

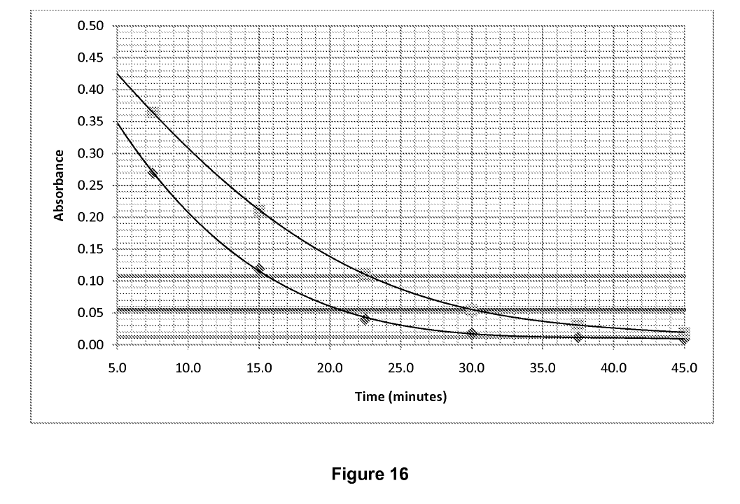

During the development of embodiments of the technology provided herein, experiments were performed to compare the localization efficiencies of the magnetic microparticle localization device using Sera-Mag SpeedBeads and Sera-Mag standard beads in a 25 centipoise solution. Test solutions comprising the appropriate magnetic beads were placed in the magnetic microparticle localization device using grade N52 magnets in the S-N configuration for testing. Samples were exposed to the magnetic field, the liquid was aspirated at the time intervals indicated for each sample, and the particles remaining in suspension were quantified by spectrometry. A decrease in absorbance indicates a decreased concentration of microparticles suspended in solution (i.e., more particles localized and removed from suspension by magnetic separation). Results are provided below in Table 5 and in FIG. 16. In FIG. 16, data collected for the Sera-Mag SpeedBeads are shown with diamonds (♦) and data collected for the Sera-Mag standard beads are shown with squares (▪).

TABLE 5

| | Standard beads | | SpeedBeads | |
|---|---|---|---|---|
| | | Particles | | Particles |
| | | remaining in | | remaining in |
| Time | Average | suspension | Average | suspension |
| (min) | absorbance | (%) | absorbance | (%) |
| 10.00 | 0.3084 | 60.72 | 0.2076 | 40.70 |
| 15.00 | 0.2120 | 41.57 | 0.1190 | 23.10 |
| 30.00 | 0.0545 | 10.23 | 0.0185 | 3.14 |
| 45.00 | 0.0185 | 3.14 | 0.0090 | 1.25 |

### Example 6

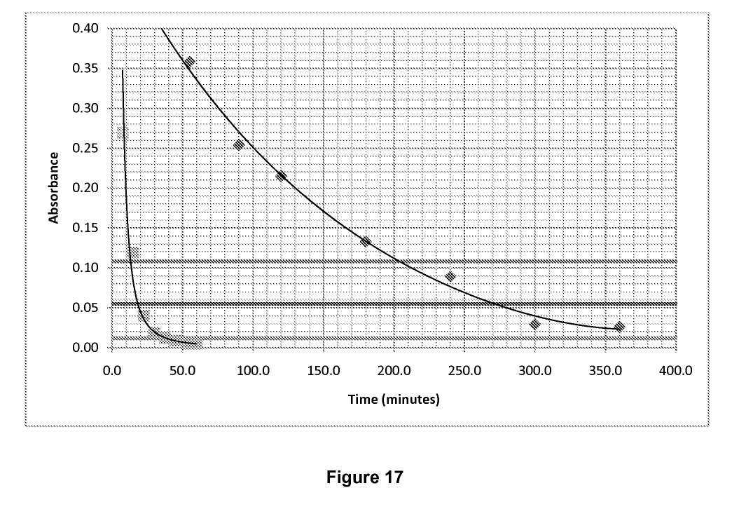

During the development of embodiments of the technology provided herein, experiments were performed to compare the localization efficiencies of the conventional technology (e.g., a Promega PolyA Tract backed with a 1-inch outer diameter×one-eighth-inch thick N52 neodymium magnet) and the magnetic microparticle localizing device using grade N52 neodymium magnets in the S-N configuration for a sample of high (i.e., 25 centipoise) viscosity comprising Sera-Mag SpeedBeads. Test solutions having a viscosity of 25 centipoise were placed in a conventional device or an embodiment of the technology provided herein for testing. Samples were exposed to the magnetic field, the liquid was aspirated at the time intervals indicated for each sample, and the particles remaining in suspension were quantified by spectrometry. A decrease in absorbance indicates a decreased concentration of microparticles suspended in solution (i.e., more particles localized and removed from suspension by magnetic separation). Results are provided below in Table 6 and in FIG. 17. In FIG. 17, data collected for the conventional device are shown with diamonds (♦) and data collected for the magnetic microparticle localization device using grade N52 neodymium magnets in the S-N configuration are shown with squares (▪).

TABLE 6

| | | |
|---|---|---|
| | | Particles remaining |
| Time | Average | in suspension |
| (min) | absorbance | (%) |

Conventional technology
(25 centipoise/SpeedBeads)

| | | |
|---|---|---|
| 10.00 | 0.4750 | 93.81 |
| 30.00 | 0.4090 | 80.70 |
| 120.00 | 0.2150 | 42.17 |
| 360.00 | 0.0260 | 4.63 |

Magnetic microparticle localization device
(25 centipoise/SpeedBeads/N52/S-N)

| | | |
|---|---|---|
| 10.00 | 0.2076 | 40.70 |
| 15.00 | 0.1190 | 23.10 |
| 30.00 | 0.0185 | 3.14 |
| 40.00 | 0.0090 | 1.25 |

### Example 7

During the development of embodiments of the technology provided herein, data were analyzed to determine the times required to capture 90% and 98% of the magnetic particles in test solutions having viscosities of 1 and 25 centipoise using the conventional technology (e.g., a Promega PolyA Tract backed with a 1-inch outer diameter×one-eighth-inch thick N52 neodymium magnet) and the magnetic microparticle localizing device in either the N-N or S-N configuration and using either grade N40 or grade N52 neodymium magnets. Results are provided below in Table 7.

TABLE 7

| | | |
|---|---|---|
| | Time for | Time for |
| | 90% capture | 98% capture |
| Device | (minutes) | (minutes) |

1 centipoise/standard beads

| | | |
|---|---|---|
| conventional | 12.00 | 19.00 |
| N-N/N40 | 1.500 | 3.23 |
| S-N/N40 | 1.10 | 2.46 |
| S-N/N52 | 1.07 | 2.98 |

25 centipoise

| | | |
|---|---|---|
| Conventional/Standard beads | 259.1 | 428.3 |
| S-N/N52/Standard beads | 20.4 | 40.8 |
| S-N/N52/SpeedBeads | 20.0 | 38.4 |
| S-N/N52 | 29.9 | 51.8 |

As shown by these data, increasing the viscosity of the fluid sample from 1 centipoise to 25 centipoise has a profound effect on efficiency due to increased viscous drag on the microparticles. Difficult stool samples are expected to range from 20 centipoise to 40 centipoise.

At vicosities of from 20 centipoise to 40 centipoise, the conventional technology is not a feasible tool for microparticle capture. For example, greater than 98% capture was not feasible with the conventional technology for a high viscosity (e.g., 25 centipoise) sample because it would take greater than 7 hours to accomplish the required localization. Moreover, after 10 minutes, only 6.2% microparticle capture was observed (see Table 6). In comparison, the magnetic microparticle localization device reached 99.8% capture after approximately 1.2 hours when configured with grade N52 neodymium magnets in the S-N configuration and using Sera-Mag SpeedBeads. After 10 minutes, ˜60% microparticle capture was observed (see Table 6).

### Example 8

During the development of embodiments of the technology provided herein, kinetic rate constants were calculated to compare the kinetics of the conventional technology (e.g., a Promega PolyA Tract backed with a 1-inch outer diameter×one-eighth-inch thick N52 neodymium magnet) and the magnetic microparticle localizing device. The data were treated as a pseudo-first order process and kinetic rate constants (k) were calculated based on the initial linear phase of the calculated curve fit.

TABLE 8

| | | |
|---|---|---|
| | Rate (k) | Rate increase relative |
| Device | (seconds⁻¹) | to conventional technology |

1 centipoise/standard beads

| | | |
|---|---|---|
| conventional | 0.208 | — |
| N-N/N40 | 1.424 | 5.83 |
| S-N/N40 | 1.704 | 7.18 |
| S-N/N52 | 2.068 | 8.93 |

25 centipoise

| | | |
|---|---|---|
| Conventional/Standard beads | 0.007 | — |
| S-N/N52/Standard beads | 0.105 | 13.20 |
| S-N/N52/SpeedBeads | 0.116 | 14.70 |
| S-N/N52 | 0.076 | 9.30 |

All publications and patents mentioned in the above specification are herein incorporated by reference in their entirety for all purposes. Various modifications and variations of the described compositions, methods, and uses of the technology will be apparent to those skilled in the art without departing from the scope and spirit of the technology as described. Although the technology has been described in connection with specific exemplary embodiments, it should be understood that the invention as claimed should not be unduly limited to such specific embodiments. Indeed, various modifications of the described modes for carrying out the invention that are obvious to those skilled in related fields (e.g., engineering, mechanics, materials science, magnetics, or medical diagnostics) are intended to be within the scope of the following claims.

We claim:

1. An article of manufacture for localizing magnetic particles in a sample comprising a first magnetic feature and a second magnetic feature, wherein a north pole of the first magnetic feature is placed in close proximity to the sample and a south pole of the second magnetic feature is placed in close proximity to the sample.

2. The article of manufacture of claim 1, further comprising a non-magnetic housing.

3. The article of manufacture of claim 2, wherein the non-magnetic housing holds the sample, the first magnetic feature, and the second magnetic feature.

4. The article of manufacture of claim 3, wherein the housing comprises a cylindrical hole for holding the sample.

5. The article of manufacture of claim 4, wherein the first magnetic feature is displaced relative to the second magnetic feature on an axis parallel to the axis of the cylindrical hole.

6. The article of manufacture of claim 5, wherein the first magnetic feature comprises a first plurality of magnets and the second magnetic feature comprises a second plurality of magnets and:
(a) the first plurality of magnets is distributed around the axis of the cylindrical hole in a first plane perpendicular to the axis of the cylindrical hole;
(b) the second plurality of magnets is distributed around the axis of the cylindrical hole in a second plane perpendicular to the axis of the cylindrical hole;
(c) the north pole of each magnet of the first plurality of magnets is nearer to the axis of the cylindrical hole than the south pole of each magnet of the first plurality of magnets; and
(d) the south pole of each magnet of the second plurality of magnets is nearer to the axis of the cylindrical hole than the north pole of each magnet of the second plurality of magnets.

7. The article of manufacture of claim 6, wherein the north and south poles of each magnet are on a line perpendicular to the axis of the cylindrical hole.

8. The article of manufacture of claim 6, wherein the first plurality of magnets comprises six magnets and the second plurality of magnets comprises six magnets.

9. The article of manufacture of claim 2, wherein the housing is made of a material chosen from the group consisting of an aluminum alloy and plastic.

10. The article of manufacture of claim 1, wherein the first magnetic feature comprises a neodymium magnet and the second magnetic feature comprises a neodymium magnet.

11. The article of manufacture of claim 1, wherein the first magnetic feature comprises an electromagnet and the second magnetic feature comprises an electromagnet.

12. The article of manufacture of claim 1, wherein the sample has a volume greater than 1 milliliter, preferably greater than 10 milliliters.

13. The article of manufacture of claim 7, wherein the cylindrical hole accommodates a 50-milliliter conical tube.

14. The article of manufacture of claim 1, wherein a first magnetic flux density produced by the first and second magnetic features is stronger than a second magnetic flux density produced by the first and second magnetic features when either:
(a) the north pole of the first magnetic feature is placed in close proximity to the sample and a north pole of the second magnetic feature is placed in close proximity to the sample; or
(b) the south pole of the first magnetic feature is placed in close proximity to the sample and a south pole of the second magnetic feature is placed in close proximity to the sample.

15. The article of manufacture of claim 1, wherein, when the sample comprises a collection of paramagnetic particles of approximately 1 to 3 micrometers in diameter and the sample has a viscosity of approximately 1 centipoise, capture of approximately 98% of the paramagnetic particles occurs within approximately 60 minutes, preferably within about 30 minutes, more preferably within about 5 minutes.

16. The article of manufacture of claim 1, wherein, when the sample comprises a collection of paramagnetic particles of approximately 1 to 3 micrometers in diameter and the sample has a viscosity of approximately 1 centipoise, capture of approximately 90% of the paramagnetic particles occurs within approximately 2 minutes.

17. An apparatus for localizing magnetic particles in a sample comprising:
(a) a feature to hold a sample; and
(b) a feature to produce a magnetic flux in the sample,
wherein the feature to produce a magnetic flux in the sample comprises a first magnet oriented with its north pole in close proximity to the sample and a second magnet oriented with its south pole in close proximity to the sample.

18. A method for localizing magnetic particles in a sample comprising:
(a) placing the sample in a magnetic field produced by a first magnet oriented with its north pole in close proximity to the sample and a second magnet oriented with its south pole in close proximity to the sample; and
(b) waiting for a time sufficient to allow the magnetic field to move the magnetic particles to the desired location.

19. The method of claim 18, wherein, when the sample comprises a collection of paramagnetic particles of approximately 1 to 3 micrometers in diameter and the sample has a viscosity of approximately 1 centipoise, capture of approximately 98% of the paramagnetic particles occurs within approximately 60 minutes, preferably within about 30 minutes, more preferably within about 5 minutes.

20. The method of claim 18, wherein, when the sample comprises a collection of paramagnetic particles of approximately 1 to 3 micrometers in diameter and the sample has a viscosity of approximately 1 centipoise, capture of approximately 90% of the paramagnetic particles occurs within approximately 2 minutes.
